(19) United States
(12) Patent Application Publication
(10) Pub. No.: US 2014/0319745 A1
(43) Pub. Date: Oct. 30, 2014

(54) FIXTURE FOR FIXING WORKPIECE WITH CURVED SURFACE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: GUANG-JIAN WANG, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/259,299

(22) Filed: Apr. 23, 2014

(30) Foreign Application Priority Data
Apr. 25, 2013 (CN) 2013101462588

(51) Int. Cl. B25B 11/00

(52) U.S. Cl. CPC B25B 11/002
USPC 269/8

(57) ABSTRACT

A fixture for fixing a workpiece with curved surface is provided. The fixture includes a first fixing member and a second fixing member magnetically attractable to the first fixing member. The workpiece is sandwiched between the first fixing member and the second fixing member. An area of the first fixing member is larger than that of the workpiece, and an area of the second fixing member is smaller than that of the workpiece.

### FIELD

The present disclosure relates to a fixture for fixing a workpiece with curved surface.

### BACKGROUND

A workpiece with beautiful curved surface can always bring nice visual aesthetics. For example, a display device may include a back cover having a curved shaped.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the drawings.

FIG. 1 is an exploded cross-sectional view of a fixture in accordance with an embodiment of the present disclosure.

FIG. 2 is an assembled cross-section view of a fixture for fixing a workpiece that is held in position by the fixture of FIG. 1.

### DETAILED DESCRIPTION

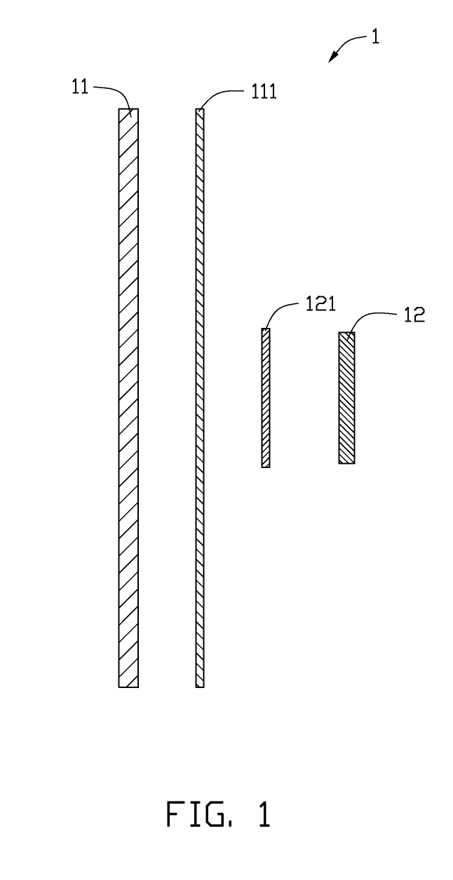

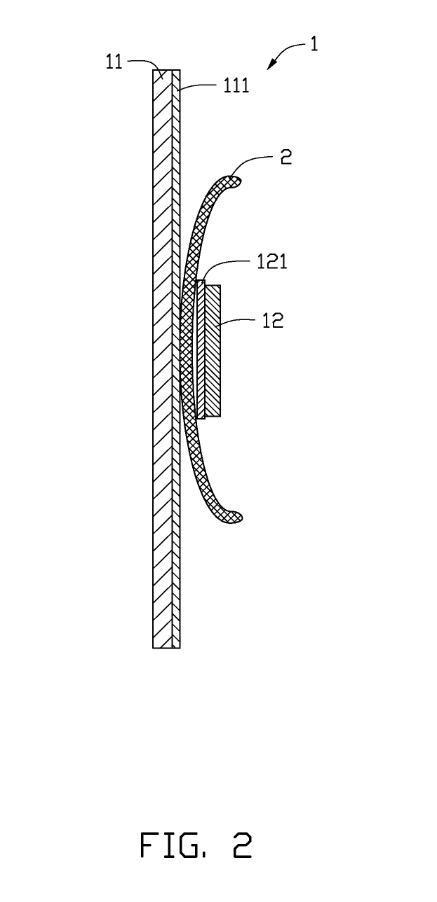

FIG. 1 illustrates an exploded cross-sectional view of a fixture 1 in accordance with an embodiment of the present disclosure. FIG. 2 is an assembled cross-section view of a fixture for fixing a workpiece that is held in position by the fixture of FIG. 1. Specifically, the fixture 1 is used for fixing a workpiece 2, which has a curved surface.

The fixture 1 can include a first fixing member 11 and a second fixing member 12. In the embodiment, the first fixing member 11 can be a magnetic plate or a metal plate with soft magnetism. The second fixing member 12 can be a magnetic plate that is able to be magnetically attracted to the first fixing member 12. In another embodiment, the first fixing member 11 and the second fixing member 12 can both have shapes adapted to the workpiece 2.

In operation, the workpiece 2 is located between the first fixing member 11 and the second fixing member 12. The second fixing member 12 is then moved toward the first fixing member 11. When the second fixing member 12 moves to a position where the first fixing member 11 can be magnetized by the second fixing member 12, and the second fixing member 12 moves toward the workpiece 2 as attracted by the first fixing member 11. The workpiece 2 is finally sandwiched between the first fixing member 11 and the second fixing member 12.

In this embodiment, an area of the first fixing member 11 is much larger than that of the workpiece 2, for example, the area of the first fixing member 11 is twenty or even three hundred times as the area of the workpiece 2. An area of the second fixing member 11 is smaller than that of the workpiece 2, for example, the area of the workpiece 2 is two times or three times as the area of the second fixing member 11.

In another embodiment, the fixture 1 may include a first fixing member 11 and a number of second fixing members 12, and each second fixing member 12 can be magnetically attractable to the first fixing member 11. In that way, the fixture 1 can fix a number of workpieces 2 simultaneously.

In the embodiment, to avoid damage or scratches to the surface of the workpiece 2, the fixture 1 can further include a first protective film 111 adhered to the first fixing member 11, and a second protective film 121 adhered to the second fixing member 12. The first protective film 111 and the second protective film 121 are both made of soft material. With the first protective film 111 and the second protective film 121 contacting the workpiece 2, the damage or scratches to the surface of the workpiece 2 can be avoided.

In other embodiments, the fixture 1 may include only a first protective film 111 adhered to the first fixing member 11.

Although the present disclosure has been specifically described on the basis of various embodiments thereof, the disclosure is not to be construed as being limited thereto. Various changes or modifications may be made to the embodiments without departing from the scope and spirit of the disclosure.

What is claimed is:

1. A fixture for fixing a workpiece with curved surface, the fixture comprising:
a first fixing member and a second fixing member magnetically attractable to the first fixing member, and
wherein the workpiece is sandwiched between the first fixing member and the second fixing member, an area of the first fixing member is larger than that of the workpiece, and an area of the second fixing member is smaller than that of the workpiece.

2. The fixture as described in claim 1, wherein the first fixing member is a magnetic plate or a metal plate with soft magnetism, and the second fixing member is a magnetic plate.

3. The fixture as described in claim 1, wherein the fixture comprises a first protective film adhered to the first fixing member.

4. The fixture as described in claim 3, wherein the fixture comprises a second protective film adhered to the second fixing member.

5. The fixture as described in claim 1, wherein the fixture comprises a first fixing member and a plurality of second fixing members, and each second fixing member is magnetically attractable to the first fixing member to fix a workpiece therebetween.
